(19) United States
(12) Patent Application Publication
(10) Pub. No.: US 2006/0224647 A1
(43) Pub. Date: Oct. 5, 2006

(54) RFID tag using updatable seed values for generating a random number

(75) Inventor: Vadim Gutnik, Irvine, CA (US)

Correspondence Address: Kimton N. Eng, Esq.;DORSEY & WHITNEY LLP, Suite 3400, 1420 Fifth Avenue, Seattle, WA, 98101, US

(73) Assignee: Impinj, Inc.

(21) Appl. No.: 11/251,122

(22) Filed: Oct. 13, 2005

Related U.S. Application Data
(60) Provisional application No. 60/667,131, filed on Mar. 30, 2005.

(51) Int. Cl. G06F 7/58

(52) U.S. Cl. 708/250

(57) ABSTRACT

Apparatus and method for generating random numbers in an RFID tag circuit. The RFID tag circuit includes a random number generator (RNG) operable to output a random number based on a seed value and further includes a non-volatile memory (NVM) register operable to store an updatable seed value that is to be used by the RNG. A tag controller included in the RFID tag is operable to select a first one, and then a second one of a plurality of values that is to become the stored seed value.

### CROSS-REFERENCE TO RELATED APPLICATION

This application claims the benefit of U.S. Provisional Application 60/667,131 entitled RFID TAGS UPDATING SEED OF PRNG, filed Mar. 30, 2005, which is incorporated herein by reference.

### TECHNICAL FIELD

The present description addresses the field of Radio Frequency IDentification (RFID) systems, and more specifically, to RFID tags able to generate random numbers.

### BACKGROUND

Radio Frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included an energy storage device, such as a battery. RFID tags with an energy storage device are known as active tags. Advances in semiconductor technology have miniaturized the electronics so much that an RFID tag can be powered solely by the RF signal it receives. Such RFID tags do not include a battery or similar energy storage device, and are called passive tags.

Some RFID tags include random or pseudo-random number generators for generating random numbers that are used for various operations of the RFID tag. For example, the random numbers can be used for generating identification codes to uniquely identify a particular RFID tag. Random numbers can also be used for generating security codes to limit accessibility to RFID circuitry to those having the proper security codes. The random numbers generated by random or pseudo-random number generators are typically provided in the form of a stream of random binary digits, or “bits.”

Pseudo-random number generators (PRNGs) are often used in RFID tags for generating “random” numbers because true random number generators can be difficult to design and implement in RFID tags. An example of a typical PRNG utilizes a linear feedback shift register (LFSR) for generating a bit sequence that is used as the random number. PRNGs of this design, however, have some limitations. For example, although a bit sequence generated by a PRNG having an LFSR is difficult to predict, the bit sequence is not truly random. The bit sequence generated by a PRNG utilizing a LFSR is based on an initial value provided to the LFSR, which is referred to as the “seed” value. Starting with a particular seed value, the bit sequence generated by the PRNG will always be the same. Thus, every time the PRNG is reset, such as when an RFID tag is powered-on, and the same initial seed value provided to the PRNG is known, the bit sequence that is generated can be predicted. In the case where the bit sequence is used for the purpose of securing the RFID tag, having an easily predictable number is undesirable.

Therefore, there is a need for a number generator that can generate different, unpredictable numbers.

### SUMMARY

In one aspect of the invention, an RFID tag circuit able to generate random numbers is provided. The RFID tag circuit includes a random number generator (RNG) operable to output a random number based on a seed value and further includes a non-volatile memory (NVM) register operable to store the seed value that is to be used by the RNG. A tag controller included in the RFID tag is operable to select a first one, and then a second one of a plurality of values that is to become the stored seed value.

In another aspect of the invention, a method for generating random numbers in an RFID tag circuit is provided. The method includes selecting a first one of a plurality of possible values as a first seed value. A RNG of the circuit is powered off, and then powered on while the selected first seed value is stored in a first NVM register of the circuit. A first random number is then generated from the RNG in response to the RNG inputting the stored first seed value. The method further includes selecting a second one of the possible values different from the first value as a second seed value. The RNG is powered off, and then powered on while the selected second seed value is stored in a second NVM register. A second random number is generated from the RNG in response to the RNG inputting the stored second seed value.

### BRIEF DESCRIPTION OF THE DRAWINGS

FIG. 1 is a block diagram of an RFID system.

FIG. 2 is a diagram showing components of a passive RFID tag.

FIG. 3 is a block diagram of an implementation of an electrical circuit of the passive RFID tag of FIG. 2.

FIG. 4 is a block diagram of an embodiment of an updatable-seed random number generator (RNG) for the processing block of the RFID tag of FIG. 3 according to embodiments.

FIG. 5 is a block diagram of an embodiment of the RNG of FIG. 4, where a stored seed value can be updated according to embodiments.

FIG. 6 is a block diagram of an embodiment of the RNG of FIG. 4, where the selection of one of various stored seed values can be updated according to embodiments.

FIG. 7 is a block diagram of an embodiment of the RNG of FIG. 4, where the seed value can be updated from the previous seed value according to embodiments.

FIG. 8 is a block diagram of an embodiment of the RNG of FIG. 4, where the seed value can be updated from the generated random number according to embodiments.

FIG. 9 is a block diagram of an embodiment of the RNG of FIG. 4, where the seed value can be updated in response to an event, according to embodiments.

FIG. 10 is a block diagram of an embodiment of the RNG of FIG. 4, where a random value can be generated in response to an event, according to embodiments.

FIG. 11 is a flow diagram for illustrating methods according to embodiments.

### DETAILED DESCRIPTION

Certain details are set forth below to provide a sufficient understanding of the invention. However, it will be clear to one skilled in the art that the invention may be practiced without these particular details. Moreover, the particular embodiments of the present invention described herein are provided by way of example and should not be used to limit the scope of the invention to these particular embodiments. In other instances, well-known circuits, control signals, timing protocols, and software operations have not been shown in detail in order to avoid unnecessarily obscuring the invention.

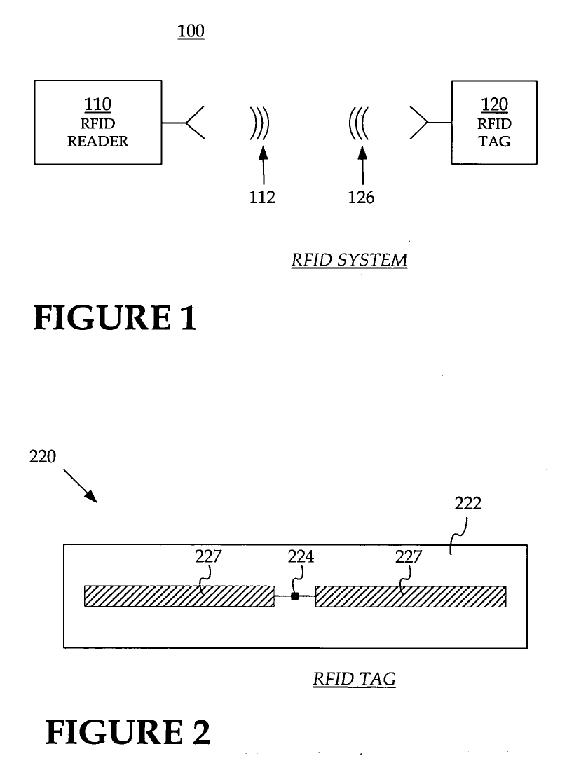

FIG. 1 is a diagram of a typical RFID system 100, incorporating aspects of the invention. An RFID reader 110 transmits an interrogating Radio Frequency (RF) wave 112. RFID tag 120 in the vicinity of RFID reader 110 may sense interrogating RF wave 112, and generate wave 126 in response. RFID reader 110 senses and interprets wave 126.

Reader 110 and tag 120 exchange data via wave 112 and wave 126. In a session of such an exchange, each encodes, modulates, and transmits data to the other, and each receives, demodulates, and decodes data from the other. The data is modulated onto, and decoded from, RF waveforms, as will be seen in more detail below.

Encoding the data can be performed in a number of different ways. For example, protocols are devised to communicate in terms of symbols, also called RFID symbols. A symbol for communicating can be a delimiter, a calibration symbol, and so on. Further symbols can be implemented for ultimately exchanging binary data, such as “0” and “1”, if that is desired.

Tag 120 can be a passive tag or an active tag, i.e. having its own power source. Where tag 120 is a passive tag, it is powered from wave 112.

FIG. 2 is a diagram of an RFID tag 220. Tag 220 is implemented as a passive tag, meaning it does not have its own power source. Much of what is described in this document, however, applies also to active tags.

Tag 220 is formed on a substantially planar inlay 222, which can be made in many ways known in the art. Tag 220 also includes two antenna segments 227, which are usually flat and attached to inlay 222. Antenna segments 227 are shown here forming a dipole, but many other embodiments using any number of antenna segments are possible.

Tag 220 also includes an electrical circuit, which is preferably implemented in an integrated circuit (IC) 224. IC 224 is also arranged on inlay 222, and electrically coupled to antenna segments 227. Only one method of coupling is shown, while many are possible.

In operation, a signal is received by antenna segments 227, and communicated to IC 224. IC 224 both harvests power, and decides how to reply, if at all. If it has decided to reply, IC 224 modulates the reflectance of antenna segments 227, which generates the backscatter from a wave transmitted by the reader. Coupling together and uncoupling antenna segments 227 can modulate the reflectance, as can a variety of other means.

In the embodiment of FIG. 2, antenna segments 227 are separate from IC 224. In other embodiments, antenna segments may alternately be formed on IC 224, and so on.

The components of the RFID system of FIG. 1 may communicate with each other in any number of modes. One such mode is called full duplex. Another such mode is called half-duplex, and is described below.

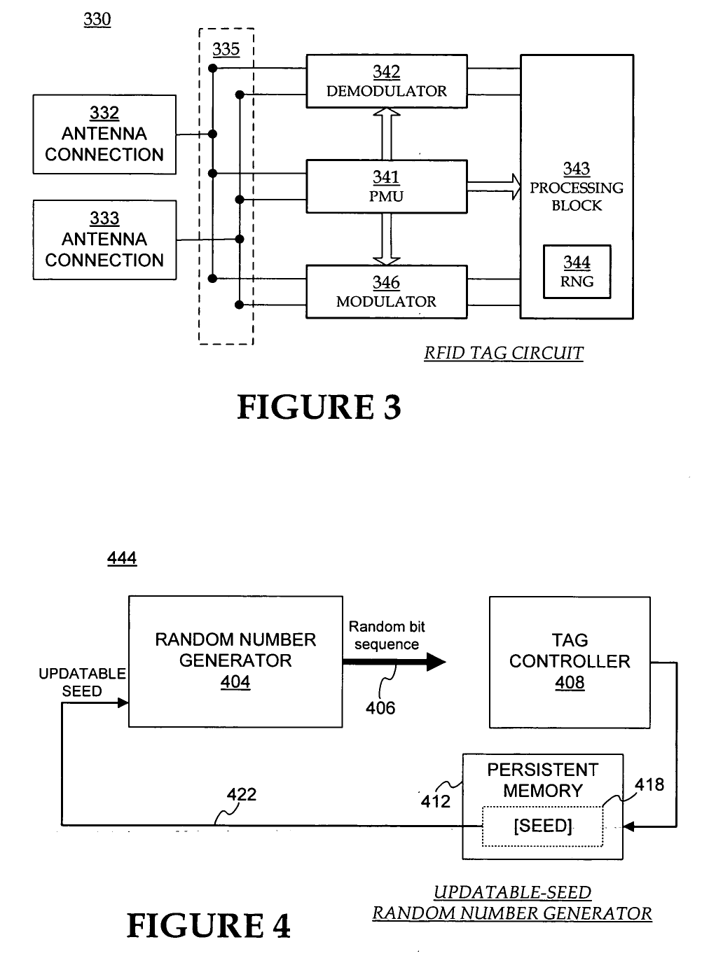

FIG. 3 is a block diagram of an electrical circuit 330. Circuit 330 may be formed in an IC of an RFID tag, such as IC 224 of FIG. 2. Circuit 330 has a number of main components that are described in this document. Circuit 330 may have a number of additional components from what is shown and described, or different components, depending on the exact implementation.

Circuit 330 includes at least two antenna connections 332, 333, which are suitable for coupling to one or more antenna segments (not shown in FIG. 3). Antenna connections 332, 333 may be made in any suitable way, such as pads and so on. In a number of embodiments more than two antenna connections are used, especially in embodiments where more antenna segments are used.

Circuit 330 includes a section 335. Section 335 may be implemented as shown, for example as a group of nodes for proper routing of signals. In some embodiments, section 335 may be implemented otherwise, for example to include a receive/transmit switch that can route a signal, and so on.

Circuit 330 also includes a Power Management Unit (PMU) 341. PMU 341 may be implemented in any way known in the art, for harvesting raw RF power received via antenna connections 332, 333. In some embodiments, PMU 341 includes at least one rectifier, and so on.

In operation, an RF wave received via antenna connections 332, 333 is received by PMU 341, which in turn generates power for components of circuit 330. This is true for either or both of when the reader 110 talks to the tag 120 (when the received RF wave carries a signal) and when the tag 120 talks to the reader 110 (when the received RF wave carries no signal).

Circuit 330 additionally includes a demodulator 342. Demodulator 342 demodulates an RF signal received via antenna connections 332, 333. Demodulator 342 may be implemented in any way known in the art, for example including an attenuator stage, amplifier stage, and so on.

Circuit 330 further includes a processing block 343. Processing block 343 receives the demodulated signal from demodulator 342, and may perform operations. In addition, it may generate an output signal for transmission.

Processing block 343 may be implemented in any way known in the art. For example, processing block 343 may include a number of components, such as a processor, a memory, a decoder, an encoder, and so on.

A RNG 344 is included in the processing block 343. The RNG 344 generates random numbers for use in various operations, as previously discussed, such as for generating identification codes to uniquely identify a particular RFID tag and for generating security codes to limit accessibility to RFID circuitry to those having proper the proper security codes. The random numbers generated by the RNG 344 are provided in the form of a random bit sequence. As will be explained in more detail below, the RNG 344 includes a pseudo-random number generator circuit that generates a bit sequence from an initial “seed” value. For a particular seed value, the sequence of bits output by the pseudo-random number generator circuit will be the same. The pseudo-random bit sequence generated by the RNG 344 is “randomized” by providing the pseudo-random number generator circuit with updated seed values from which a bit sequence is generated. Various embodiments of random number generators that can be substituted for the RNG 344 will be described in more detail below.

Circuit 330 additionally includes a modulator 346. Modulator 346 modulates an output signal generated by processing block 343. The modulated signal is transmitted by driving antenna connections 332, 333, and therefore driving the load presented by the coupled antenna segment or segments. Modulator 346 may be implemented in any way known in the art, for example including a driver stage, amplifier stage, and so on.

In one embodiment, demodulator 342 and modulator 346 may be combined in a single transceiver circuit. In another embodiment, modulator 346 may include a backscatter transmitter or an active transmitter. In yet other embodiments, demodulator 342 and modulator 346 are part of processing block 343.

It will be recognized at this juncture that circuit 330 can also be the circuit of an RFID reader according to the invention, without needing PMU 341. Indeed, an RFID reader can typically be powered differently, such as from a wall outlet, a battery, and so on. Additionally, when circuit 330 is configured as a reader, processing block 343 may have additional Inputs/Outputs (I/O) to a terminal, network, or other such devices or connections.

FIG. 4 illustrates an embodiment of a RNG. RNG 444 is an updatable-seed RNG that can be substituted for the RNG 344 (FIG. 3). The RNG 444 includes a RNG circuit 404 that generates a bit sequence 406 based on a seed value that is provided to the RNG 444. As previously discussed, the random bit sequence 406 can be used in various operations of the RFID tag. The RNG 444 further includes a tag controller 408 and a persistent memory 412. The tag controller 408 is operable to compute new seed values, which are in turn stored in the persistent memory 412 as seed value 418. Once stored in the persistent memory 412, the seed value 418 is retained even when power is not provided. The seed value 418 is provided over a signal line 422 that is configured to transfer the seed value 418 from the persistent memory 412 to the RNG circuit 404 for generating a bit sequence. By generating new seed values 418 that are used by the RNG circuit 404 to generate sequences of bits, different and relatively unpredictable bit sequences can be generated by the RNG 404.

The new seed values can be generated by the tag controller 408 in different ways. For example, the tag controller 408 can compute a new seed value from a number related to the particular RFID tag, such as a stored encoded identification number (e.g., product number, manufacturer identification number, and the like), or a received signal strength indicator (RSSI). As will be described in more detail below, new seed values can also be computed from a previous seed value or from a random bit sequence generated using a previous seed value. Techniques other than those specifically described herein can be used as well. Additionally, a combination of various techniques for computing new seed values can also be used.

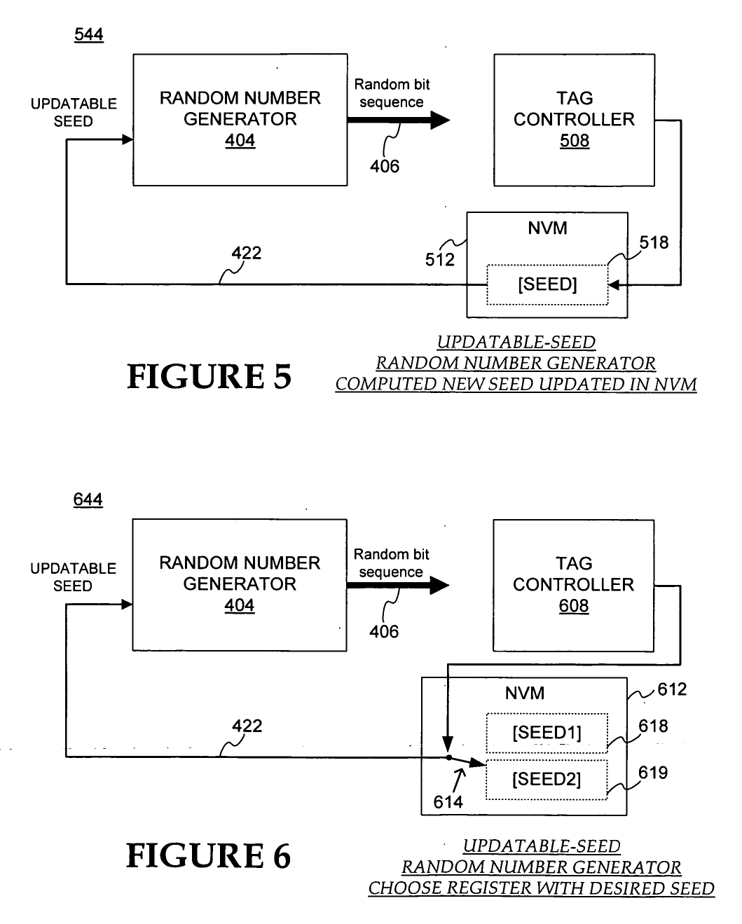

FIG. 5 illustrates an embodiment of the RNG 444 of FIG. 4, where a stored seed value can be updated and then stored in a NVM 512. RNG 544 includes a RNG circuit 404 that operates as previously described with respect to FIG. 4. The RNG 544 further includes a tag controller 508 and the NVM 512. The tag controller 508 computes an updated seed value that is written to the NVM 512 as seed value 518. As with the RNG 444, the seed value 518 is provided on signal line 422 to the RNG circuit 404 for generating a random bit sequence 406. In response to receiving the seed value 518, the RNG circuit 404 generates a sequence of random bits that are based on the seed value 518.

FIG. 6 illustrates another embodiment of the RNG 444 of FIG. 4, where the selection of one of various stored seed values can be updated. RNG 644 includes a RNG circuit 404 that operates as previously described with respect to FIG. 4. The RNG 644 includes a tag controller 608 and further includes a NVM 612 for storing a plurality of seed values, represented in FIG. 6 as seed values 618, 619. A switch 614 under the control of the tag controller 608 is used to select one of the plurality of seed values 618, 619 to be provided to the RNG circuit 404 over the signal line 422 and used for generating a random bit sequence 406. The switch 614 can represent a switch circuit as well as other selection circuits and selection mechanisms for selecting one of the plurality of seed values 618, 619 to be provided to the RNG circuit 404. For example, the tag controller 608 can control the NVM 612 to output a selected one of the plurality of seed values 618, 619 to the signal line 422 using conventional non-volatile memory control signals.

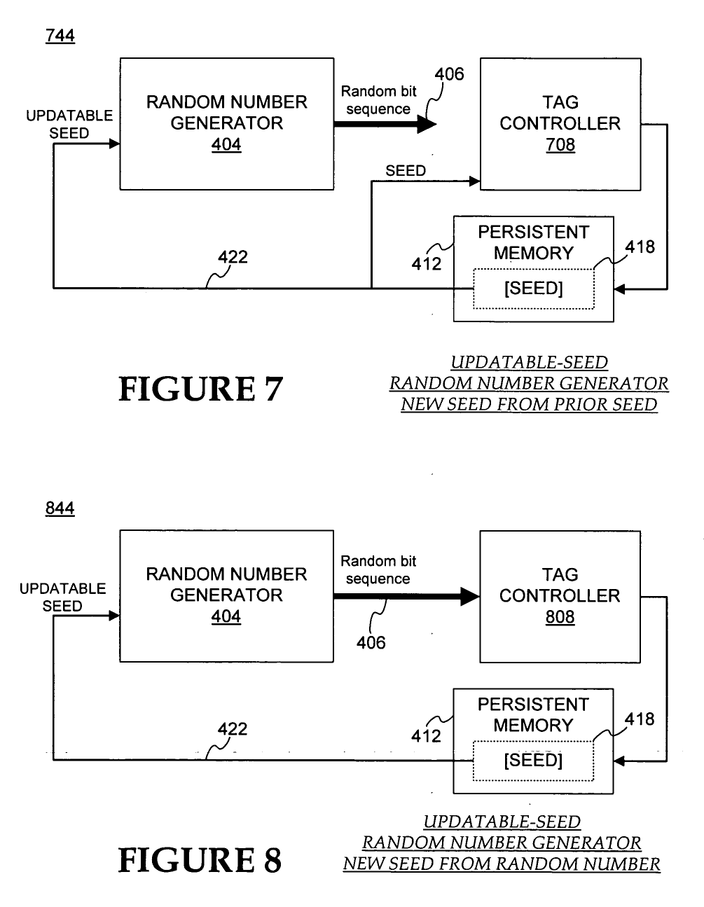

FIG. 7 illustrates another embodiment of the RNG 444 of FIG. 4, where a seed value can be updated from a previous seed value and stored in persistent memory 412. RNG 744 includes a RNG circuit 404 that operates as previously described with respect to FIG. 4. The RNG further includes the persistent memory 412 for storing a seed value 418 that is computed by a tag controller 708. In the embodiment of the RNG 744 shown in FIG. 7, the seed value 418 is provided to the RNG circuit 404 as well as to the tag controller 708. The RNG circuit 404 generates a random bit sequence 406 based on the seed value 418. The tag controller 708 uses a previously stored seed value 418 to compute a new seed value, which is then stored in the persistent memory 412. In this manner, the new seed value computed by the tag controller 708 is stored in the persistent memory 412 and can be provided to the RNG circuit 404 at a later time to change the seed value on which the random bit sequence 406 generated by the RNG circuit 404 is based. An example technique that can be used by the tag controller 708 for computing a new seed value is to increment a previously stored seed value. Other techniques, however, can be used as well.

FIG. 8 illustrates another embodiment of the RNG 444 of FIG. 4, where a seed value can be updated from a generated random number. RNG 844 includes a tag controller 808 that computes a new seed value from the random bit sequence 406 that is based on a previous seed value. The new seed value is stored in persistent memory 412 as seed value 418 to be provided to RNG circuit 404 at a later time to switch the seed value on which the random bit sequence 406 is based. An example of computing a new seed value from a random bit sequence 406 is selecting a number of bits from the random bit sequence 406 that is generated in response to a previous seed value 418 as a new seed value. A number of initial bits can also be discarded from the random bit sequence 406 generated in response to the current seed value 418 before selecting the number of bits to be used as the new seed value to allow for the sequence of bits to stabilize. Other methods for computing a seed value 418 from a random bit sequence 406 can be used as well.

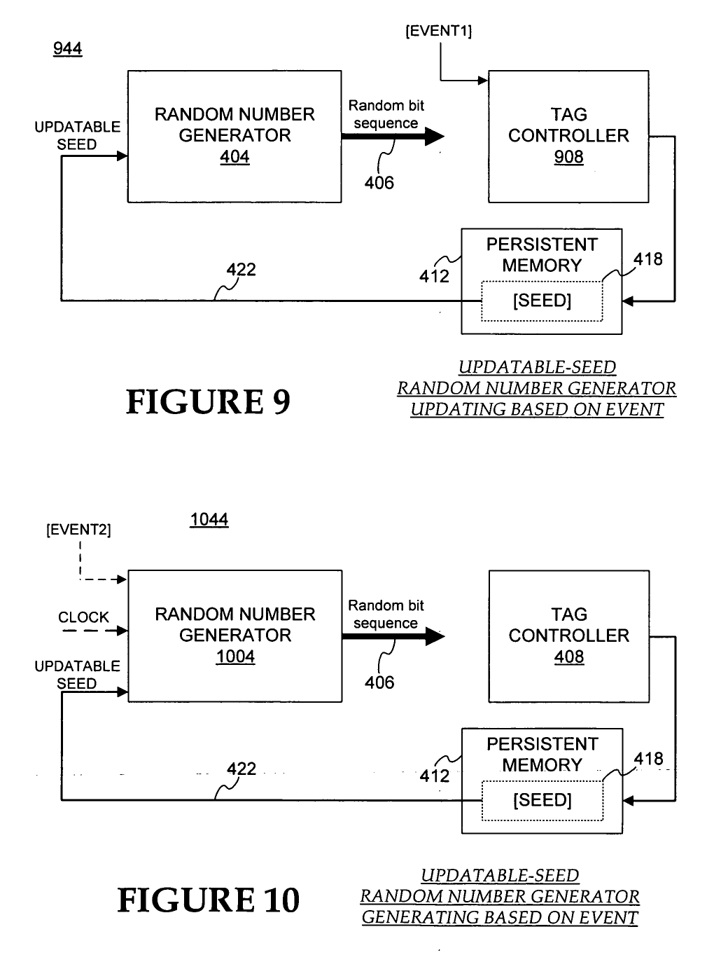

FIG. 9 illustrates another embodiment of the RNG 444 of FIG. 4, where a seed value can be updated in response to an event. RNG 944 includes a tag controller 908, which computes a new seed value 418 for storage in persistent memory 412 in response to an event. The occurrence of the event can be indicated by a signal, such as an EVENT1 signal shown in FIG. 9. As with the previous embodiments of RNGs, the seed value 418 is provided to a RNG circuit 404 on signal line 422 for generating a random bit sequence 406. Examples of events that can be used to trigger the computation of a new seed value 418 include receiving a particular command, such as a command that is issued to the RFID tag by a RFID reader, entering a particular operating state or changing from a first state to a second state, and resetting the RFID tag upon being powered-on. In the case of triggering computation of a new seed value 418 in response to the RFID tag being powered-on and reset, a power-on reset circuit (not shown) that generates a signal in response to powering-on the RFID tag can be used to generate the EVENT1 signal. Although specific examples of events for triggering computation of a new seed value 418 have been described, other events can be used as well.

FIG. 10 illustrates another embodiment of the RNG 444, of FIG. 4 where a random number is generated in response to an event. RNG 1044 includes a tag controller 408 that computes a new seed value 418 that is stored in persistent memory 412. The RNG 1044 further includes a RNG circuit 1004 that generates a random bit sequence based on a seed value 418 in response to receiving an EVENT2 signal. The EVENT2 signal is generated in response to the occurrence of an event, for example, power-on reset (POR) of the RFID tag or receiving a command signal from the tag controller 408. The RNG circuit 1004 can also receive a clock signal CLOCK for synchronizing generation of the random bit sequence 406 to the CLOCK signal. For example, the RNG 1004 can generate a new bit in the random bit sequence 406 in response to edges of the CLOCK signal. Although specific examples of events for triggering generation of a random number based on a seed value have been described, other events can be used as well.

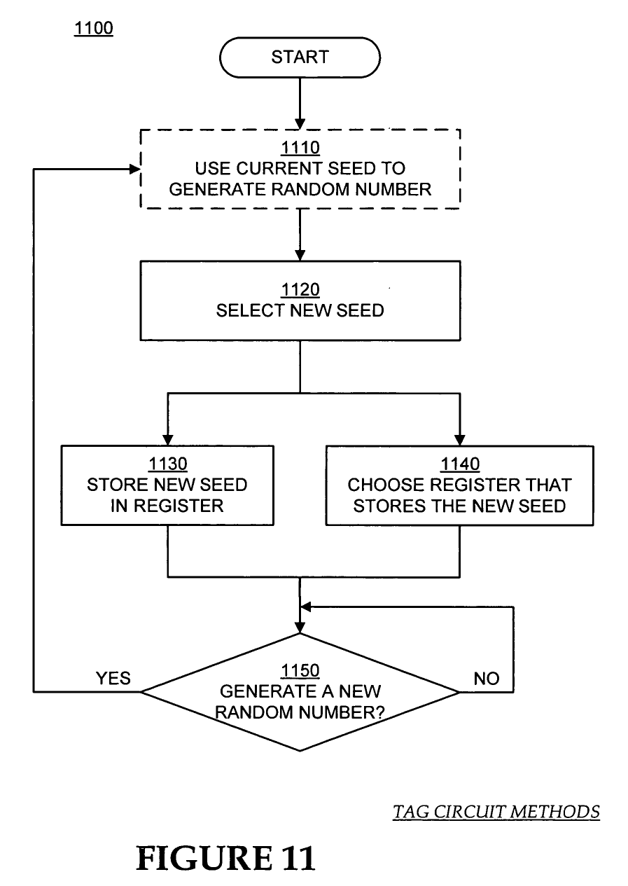

FIG. 11 illustrates a flow diagram for an embodiment of generating random numbers. The method can be implemented using the previously described embodiments of RNGs. At step 1110 a current seed value is used to generate random numbers, such as a random bit sequence. At step 1120 a first one of a plurality of possible values is selected as a new seed value. As previously discussed, the new seed value can be selected using different approaches, for example, computing a new seed value from a previous seed value, computing a new seed value from the random bit sequence generated by a RNG circuit, and computing a new seed value from information for the RFID tag, such as the RSSI or a stored encoded identification number. Other approaches not specifically described herein, as well as combinations of different approaches, can also be used.

The new seed value is stored at step 1130 in a register or other memory and the register storing the new seed value to be provided to a RNG circuit is selected at step 1140. The register or memory is preferably a persistent memory that can retain the new seed value although the RFID tag is without power. At step 1150 a decision whether to generate random numbers based on the new seed value is made. When random numbers based on another seed value are to be generated, the seed value stored by the selected register is used as the basis for generating new random numbers. Steps 1120-1140 are then repeated to select and store a new seed value, and further select a register storing the seed value that will to be provided to the RNG and used for generating new random numbers.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An RFID tag circuit, comprising:
a random number generator (RNG) operable to output a random number based on a seed value;
a non-volatile memory (NVM) register operable to store the seed value that is to be used by the RNG; and
a tag controller operable to select a first one, and then a second one of a plurality of values that is to become the stored seed value.

2. The circuit of claim 1, wherein
the RNG is a pseudo-random number generator.

3. The circuit of claim 1, wherein
the RNG is coupled to the NVM register for receiving as the seed value the value stored in the register, and
the tag controller is adapted to cause the selected first and second values to become stored in the register.

4. The circuit of claim 1, further comprising:
at least another NVM register, and
wherein a first one of the registers stores a first one of the possible values,
a second one of the registers store a second ones of the possible values, and
the tag controller is adapted to select by controlling which of the first and second registers the RNG will input a seed value from.

5. The circuit of claim 1, wherein
the second value is selected from the first value.

6. The circuit of claim 1, wherein
the second value is selected by incrementing the first value.

7. The circuit of claim 1, wherein
the second value is selected from a first random number.

8. The circuit of claim 1, wherein
the second value is selected responsive to an event.

9. The circuit of claim 1, wherein
the second value is selected responsive to the RNG becoming powered up.

10. The circuit of claim 1, wherein
the second value is selected responsive to the RNG receiving a POR signal from a Power On Reset circuit.

11. The circuit of claim 1, wherein
the second value is selected responsive to a state machine of the tag transitioning from a first state to a second state.

12. An RFID tag circuit, comprising:
a first selecting means for selecting a first one of a plurality of possible values as a first seed value;
a first means for powering off, and then powering on a random number generator (RNG) of the circuit and a first non-volatile memory (NVM) register of the circuit, while the selected first seed value is stored in the first register;
a first generating means for generating from the RNG a first random number in response to the RNG inputting the stored first seed value;
a second selecting means for selecting a second one of the possible values different from the first value as a second seed value;
a second means for powering off, and then powering on the RNG while the selected second seed value is stored in a second NVM register; and
a second generating means for generating from the RNG a second random number in response to the RNG inputting the stored second seed value.

13. The circuit of claim 12, wherein
the RNG is a pseudo-random number generator.

14. The circuit of claim 12, wherein
the first and second NVM registers are the same.

15. The circuit of claim 12, wherein
the first NVM register is different from the second NVM register.

16. The circuit of claim 12, wherein
the second value is selected from the first value.

17. The circuit of claim 12, wherein
the second value is selected by incrementing the first value.

18. The circuit of claim 12, wherein
the second value is selected from the first random number.

19. The circuit of claim 12, wherein
the second value is selected responsive to an event.

20. The circuit of claim 12, wherein
the second value is selected responsive to the RNG becoming powered up.

21. The circuit of claim 12, wherein
the second value is selected responsive to the RNG receiving a POR signal from a Power On Reset circuit.

22. The circuit of claim 12, wherein
the second value is selected responsive to a state machine of the tag transitioning from a first state to a second state.

23. The circuit of claim 12, wherein
the first and second generating means are the same.

24. The circuit of claim 12, wherein
the first and second selecting means are the same.

25. The circuit of claim 12, wherein
the first and second means for powering off, and then powering on the RNG are the same.

26. A method for an RFID tag circuit, comprising:
selecting a first one of a plurality of possible values as a first seed value;
powering off, and then powering on a random number generator (RNG) of the circuit and a first non-volatile memory (NVM) register of the circuit, while the selected first seed value is stored in the first register;
then generating from the RNG a first random number in response to the RNG inputting the stored first seed value;
then selecting a second one of the possible values different from the first value as a second seed value;
then powering off, and then powering on the RNG while the selected second seed value is stored in a second NVM register; and
then generating from the RNG a second random number in response to the RNG inputting the stored second seed value.

27. The method of claim 26, wherein
the RNG is a pseudo-random number generator.

28. The method of claim 26, wherein
the first and second NVM registers are the same.

29. The method of claim 26, wherein
the first NVM register is different from the second NVM register.

30. The method of claim 26, wherein
the second value is selected from the first value.

31. The method of claim 26, wherein
the second value is selected by incrementing the first value.

32. The method of claim 26, wherein
the second value is selected from the first random number.

33. The method of claim 26, wherein
the second value is selected responsive to an event.

34. The method of claim 26, wherein
the second value is selected responsive to the RNG becoming powered up.

35. The method of claim 26, wherein
the second value is selected responsive to the RNG receiving a POR signal from a Power On Reset circuit.

36. The method of claim 26, wherein
the second value is selected responsive to a state machine of the tag transitioning from a first state to a second state.
